(19) United States
(12) Patent Application Publication
(10) Pub. No.: US 2022/0373228 A1
(43) Pub. Date: Nov. 24, 2022

(54) DEVICE WITH A HEAT EXCHANGER

(71) Applicant: ecool advanced urban engineering gmbh, Wien (AT)

(72) Inventors: Ursula HOFBAUER, Wien (AT); Dragos Alexandru BAUR, Pralea (RO)

(21) Appl. No.: 17/770,950

(22) PCT Filed: Oct. 5, 2020
(86) PCT No.: PCT/EP2020/077867

§ 371 Date: Apr. 21, 2022

(30) Foreign Application Priority Data
Oct. 22, 2019 (AT) A 50912/2019

(51) Int. Cl. F24S 20/40; F24S 10/30

(52) U.S. Cl. CPC F24S 20/40; F24S 10/30

(57) ABSTRACT

Disclosed is a device with a heat exchanger having a first flow through which a first gaseous heat transfer medium passes and a second flow through which a second gaseous heat transfer medium passes. Upstream of the first flow, there is a combustion chamber, which optionally extends into the first flow. Two feed lines are attached to the first flow, of which the first feed line is connected to a thermal solar installation and the second feed line is connected to a source for a combustible gas-air mixture or for a non-combustible gas, in particular an oxygen-containing gas, such as air.

This application is the U.S. national phase of International Application No. PCT/EP2020/077867 filed Oct. 5, 2020 which designated the U.S. and claims priority to AT A 50912/2019 filed Oct. 22, 2019, the entire contents of each of which are hereby incorporated by reference.

### BACKGROUND OF THE INVENTION

### Field of the Invention

The invention relates to a device with a heat exchanger with a first flow, through which a first gaseous heat transfer medium passes, and with a second flow, through which a second gaseous heat transfer medium passes, wherein upstream from the first flow, there is arranged a combustion chamber, which optionally extends into the first flow.

### Description of the Related Art

Known from US 2018/0347858 A1 is such a device, in which a thermal solar installation is combined with a burner for an air-gas mixture. The known device, however, is disadvantageous, since the burner must be arranged directly in the area of the solar installation or its concave mirror, which represents a certain safety risk, and under certain circumstances, the heat exchanger is far away from the installation in which the generated heat is required.

### SUMMARY OF THE INVENTION

The object of the invention is to provide corrective actions here.

According to the invention, two feed lines are attached to the first flow, the first feed line of which is connected to a thermal solar installation. The second feed line can, if necessary, be connected to a source for a combustible gas-air mixture or for a non-combustible gas, in particular an oxygen-containing gas, such as air. When the thermal solar installation produces enough heat, only the heated gas from the solar installation is fed to the first flow of the heat exchanger. When the thermal solar installation does not produce enough heat, only combustible gas-air mixture is fed to the first flow of the heat exchanger in one embodiment of the invention, which mixture is burned in the combustion chamber.

To ignite the combustible gas-air mixture, an igniting system can, if necessary, be arranged in the combustion chamber.

In order to control the flow through the feed lines, it can be provided in one embodiment of the invention that a valve is arranged in the second feed line, which valve connects the second feed line to a line to the thermal solar installation and interrupts the connection of the second feed line to the heat exchanger or controls the flow through the second feed line. The gas of the second feed line (in this first case, a combustible gas-air mixture) can thus be fed either directly to the heat exchanger or the gas (in this second case, for example, pure air) is not fed directly to the heat exchanger, but rather is diverted over the line to the solar installation and its first feed line if a solar operation is possible. A preferred temperature range at which the gas of the solar installation is heated is within the order of magnitude of 500° C. to 1500° C., preferably between 600° C. and 1200° C., especially preferably between 700° C. and 1000° C.

An embodiment of the invention is also possible in which the gas fed to the solar installation is not only pure air, but rather fuel is also fed to the latter, which fuel subsequently burns in the combustion chamber. This embodiment is advantageous when the gas, e.g., in the case of overcast skies, is heated in the solar installation but not to a high enough temperature. Gas at a high enough temperature can ultimately be produced in the combustion chamber by the fuel. In this embodiment, it should be ensured that the temperature at which the gas is heated in the solar installation and the degree of saturation of the fuel-air mixture are matched to one another, so that there is no combustion or deflagration in the solar installation. The temperature range at which the gas is heated in the solar installation in this embodiment is preferably between 400° C. and 600° C., and the mixing ratio of the fuel-air mixture is hyper-stoichiometric, i.e., excess air is present, preferably at a ratio of 1.5:1 to 3:1, preferably 2:1 to 2.5:1.

If the temperature of the gas in the solar installation is not high enough, in an alternative embodiment of the invention, fuel can also be fed by means of a system directly into the combustion chamber (sprayed in the case of liquid fuels or injected in the case of gaseous fuels). The system for feeding fuel can also be used when the solar installation is not in operation at all and only an oxygen-containing gas, such as air, is fed through the second feed line directly to the combustion chamber.

Gas, in particular biogas or hydrogen, is preferably used as fuel.

When control valves are used rather than cutoff valves or changeover valves, other mixed forms of operation can be achieved.

One advantage of the device according to the invention is in any case that the heat exchanger must not be located in immediate proximity to the thermal solar installation and that because of the separate feeding of gas from the solar installation through the first feed line and of the optionally combustible gas-air mixture through the second feed line and the above-described combination options, more reliable and easily controllable operational management is made possible.

Within the scope of the invention, any known thermal solar installation can be used, with which a hot gas, preferably hot air, can be produced at the desired temperature.

It is preferred within the scope of the invention, however, when the solar installation has a concave mirror, preferably a parabolic mirror, i.e., a concave mirror in the form of a paraboloid of revolution, since with such a mirror, high temperatures can be generated at the focal point of the mirror.

In the invention, the concave mirror must not have the shape of an ideal parabolic mirror in its entirety, although this is advisable for optimum use of the solar energy. It can also be sufficient, however, when the concave mirror has a parabolically-curved mirror surface at least in sections. In particular, the concave mirror in sections can also have a (optionally approximately) cone-shaped mirror surface.

Since the concave mirror is usually located outdoors, it is advantageous when the latter can be protected from effects of the weather, in particular strong wind. This is done according to the invention in that the mirror surface is formed at least in part from adjustable sections.

For this purpose, there are multiple options in turn according to the invention. One option is that on its base, the concave mirror will have a bowl with a parabolic mirror surface and that the adjustable sections are arranged to pivot on the bowl. The fins that are mounted to pivot on the edge of the bowl and that extend essentially in the direction of the generatrixes of the concave mirror or parabolic mirror can be pivoted inward, i.e., approximately in the direction toward the center of the mirror, at which point not only is the attack surface of the concave mirror reduced, but also the mirror surfaces of both the bowl and the fins are protected, since the bowl is covered by the fins and the mirror surfaces of the fins are folded inward or downward.

In an alternative embodiment, the adjustable sections are annular fins that, starting from the bowl, are aligned in the direction of the axis of the paraboloid. That is to say that an annular fin connects to the bowl and the additional, optionally present annular fin(s) then connects or connect successively to one another when the concave mirror is located in its operating position. When the solar installation is not in operation, the annular fins can be lowered in the direction of the axis of the concave mirror or parabolic mirror, so that the latter are approximately at the height of the bowl and surround the latter.

When using a concave mirror or a parabolic mirror, a heating head is arranged in its interior, preferably at the focal point.

In the invention, it is also possible or preferred when at least one section of the concave mirror is approximately the shape of a cone, and optionally in addition, a base or a subpart of the concave mirror is shaped like a paraboloid of revolution or the like. This makes it possible to focus the sun rays not specifically on the focal point at which the heating head is found, which in particular in the case of larger concave mirrors would generate very high local temperatures in individual areas of the heating head, but rather to distribute the rays uniformly onto the illuminated surface of the heating head.

According to the invention, the heating head is arranged on the end of a holding device, which has two concentric, preferably insulated, pipes, which between them form a line in the form of an annular gap, through which the supply of cooler gaseous heat transfer medium to the heating head is done, wherein the removal of hotter, gaseous heat transfer medium is done through the inner pipe.

The heating head is thus arranged on a holding device, wherein the holding device is itself formed not necessarily but preferably by the two concentric pipes. As a result, a very simple design of the device is produced.

Another possibility for protecting the concave mirror from effects of the weather consists according to the invention in that the concave mirror is arranged to move relative to the holding device and the heating head. In this way, the concave mirror, when the holding device is arranged, for example, to be vertical, can be moved from a raised position into a lowered position. In this lowered position, the concave mirror can also be protected, if necessary, by a housing, roof, or the like.

The holding device itself with the heating head is in this case preferably arranged to be stationary, which offers the advantage that the heating head, which is optionally still very hot from its operation, also remains in the original operating position when the concave mirror is lowered, in which position the danger that a fire will be started by the still-hot heating head is extremely low.

In order to have the solar installation track the sun, the concave mirror—as is known in the art—can be arranged to pivot in the vertical direction relative to the holding device. To this end, the concave mirror can have a slot that, preferably starting from the axis of the concave mirror, is arranged along a generatrix of the concave mirror, wherein the holding device is run through the slot.

Additional preferred embodiments of the invention are the subject matter of the other subclaims.

### BRIEF DESCRIPTION OF THE DRAWINGS

Additional features and advantages of the invention are given in the following description of preferred embodiments of the invention that do not limit the scope of protection with reference to the attached drawings. Here:

FIG. 1 shows an embodiment, according to the invention, of a heat exchanger that can be used in the device according to the invention in a first operating position,

FIG. 2 shows the heat exchanger of FIG. 1 in a second operating position,

FIG. 3 shows a first embodiment, according to the invention, of a thermal solar installation with pivotable fins,

FIG. 4 shows a top view of the solar installation of FIG. 3,

FIG. 5 shows the solar installation of FIG. 3 in an operating position and in section,

FIG. 6 shows the solar installation of FIG. 5 from the left,

FIG. 7 shows a top view of a bowl of the solar installation without fins,

FIG. 8 shows the solar installation of FIG. 3 in a resting position with inward-pivoted fins,

FIG. 9 shows the solar installation in the position of FIG. 8 in top view,

FIG. 10 shows a positioning mechanism of the solar installation of FIGS. 3 to 9,

FIG. 11 shows a second embodiment of the solar installation according to the invention in the operating position and in section,

FIG. 12 shows the solar installation of FIG. 11 with inward-pivoted fins,

FIG. 13 shows the solar installation of FIGS. 11 and 12 in top view, wherein only some of the fins are pivoted inward,

FIG. 14 shows a third embodiment of the solar installation according to the invention in the operating position,

FIG. 15 shows the solar installation of FIG. 14 with inward-pivoted fins in the resting position,

FIG. 16 shows the solar installation in the position of FIG. 15 from above,

FIG. 17 shows the solar installation according to FIGS. 14 to 16, in which only one part of the fins is pivoted inward,

FIG. 18 shows a top view of the bowl of the solar installation of FIGS. 14 to 17 without fins,

FIG. 19 shows a fourth embodiment of the solar installation according to the invention in the operating position,

FIG. 20 shows the embodiment of FIG. 19 in the operating position and in section,

FIG. 21 shows a detail of the embodiment of FIGS. 19 and 20 in section,

FIG. 22 shows the embodiment of FIGS. 19 to 21 in an intermediate position between the operating position and the resting position,

FIG. 23 shows the embodiment of FIGS. 19 to 22 in the resting position,

FIG. 24 shows a detail of a fifth embodiment of the solar installation according to the invention in the operating position and in section,

FIG. 25 shows a sixth embodiment of the solar installation according to the invention in the operating position,

FIG. 26 shows a detail of the embodiment of FIG. 25 in the operating position and in section,

FIG. 27 shows the detail of the embodiment of FIGS. 25 and 26 in the resting position,

FIG. 28 shows the effect of the geometry of the concave mirror on the irradiation on a heating head of the solar installation,

FIG. 29 shows an embodiment, according to the invention, of a heating head of the solar installation,

FIG. 30 shows the heating head of FIG. 29 in section, and

FIG. 31 shows a detail of an improved embodiment of a heating head.

### DESCRIPTION OF THE PREFERRED EMBODIMENTS

In the drawings, embodiments of devices according to the invention are depicted, which devices, however, are intended only as examples and, aside from the features according to the invention as defined in the claims, can also be implemented differently within the scope of this invention as regards many components, without this requiring special mention below.

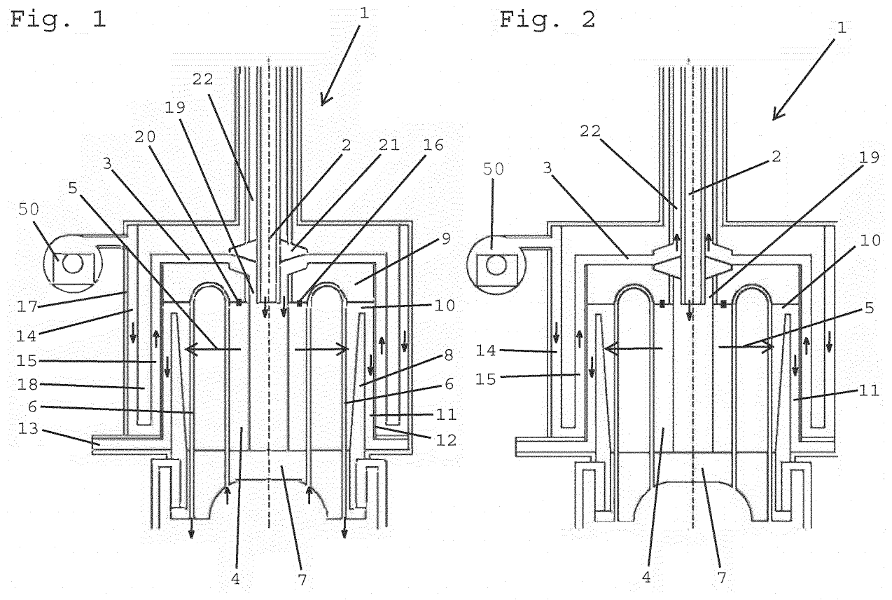

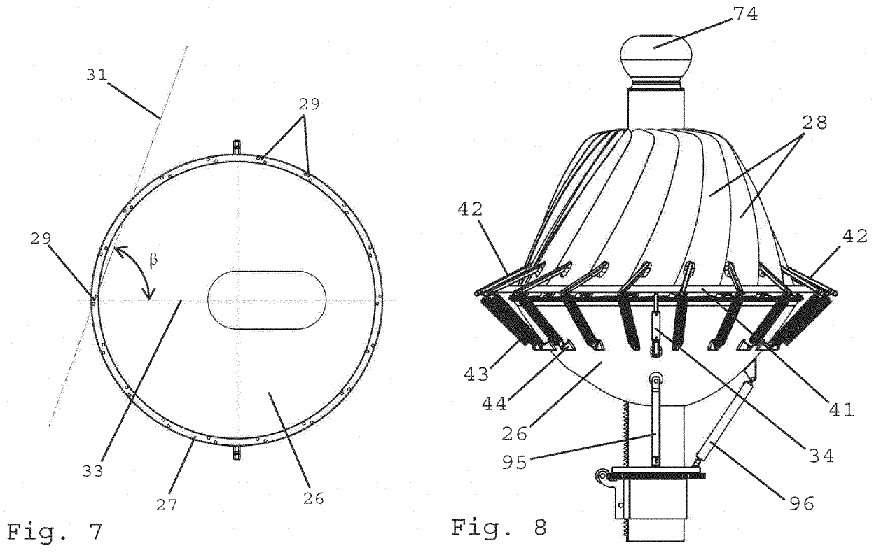

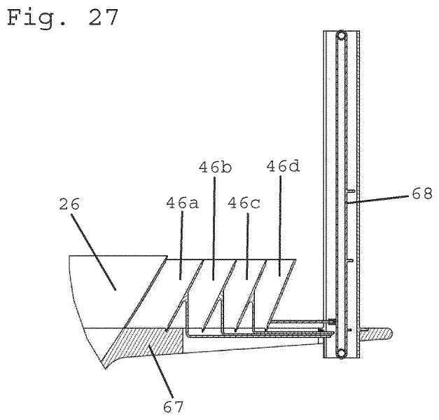

In FIG. 1, an embodiment, according to the invention, of a heat exchanger 1 is depicted, which heat exchanger can be used in the device according to the invention. The heat exchanger 1 has a first feed line 2 for a gaseous heat transfer medium, for example, air, which is connected to a thermal solar installation, as it is depicted in, for example, FIGS. 2 to 29. With a second feed line 3, either air or a combustible gas-air mixture is fed to the heat exchanger 1 by a source 50.

The two feed lines empty into a combustion chamber 4, from which a first flow starts from the heat exchanger 1, which is indicated symbolically by the arrow 5. A second flow from the heat exchanger is formed by, for example, pipes 6, through which flows an additional fluid heat transfer medium, which is preferably gaseous, but can also be liquid for certain applications. The combustion chamber 4 is bounded by a base 7, in which the pipes 6 are mounted, a boundary wall 8, and a cover 9. The base 20 can form the wall of a cylinder, e.g., of a compression thermal engine, at the same time.

Between the boundary wall 8 and the cover 9, there is an open annular gap 10, through which the gaseous heat transfer medium can escape from the chamber 4 after it has released a large part of its heat to the heat transfer medium in the pipes 6. After the gaseous heat transfer medium has exited from the chamber 4 through the annular gap 10, it escapes downward and through an outlet 13 through an inner annular space 11, which is bounded by the boundary wall 8 and an inner dividing wall 12. In this case, residual heat is transferred from the escaping gas to the inflowing gas.

The gas fed by the second feed line 3 is first run through two annular spaces 14, 15, and the first flow 5 also enters into the combustion chamber 4 in the position, depicted in FIG. 1, of a valve 21 through an opening 19. In this case, the outer annular space 14 is bounded by an outside wall 17 and an outer dividing wall 18, and the middle annular space 15 is bounded by the outer dividing wall 18 and the inner dividing wall 12. The inner dividing wall 12 also serves as a heat exchanger in order to transfer residual heat of the gas escaping from the heat exchanger 1 through the inner annular space 11 to the gas that flows in through the middle annular space 15.

The valve 21, with which the flow of the gas that flows in through the middle annular space 15 can be diverted, is located upstream from an inlet opening 19. When the valve is in the position that is depicted in FIG. 1, the gas, as already mentioned, is routed from the middle annular space 15 and over the second feed line 3 through the inlet opening 19 into the chamber 4. When the valve 21 is in the position depicted in FIG. 2, however, the inlet opening 19 is closed, and the gas is routed to the thermal solar installation through a line in the form of an annular gap 22, which extends around the first feed line 2. There, the gas is heated and subsequently routed through the first feed line 2 into the chamber 4.

The gas, which in the case of a valve position according to FIG. 2 is routed through the line 22 to the thermal solar installation, can be, for example, air or another gas or fuel-air mixture.

In one embodiment of the invention, fuel can be fed directly into the combustion chamber 4 by means of a system, for example one or more nozzles 20. The heat exchanger 1 according to the invention can then be used even if the solar installation is not in operation at all or does not provide enough heat, and only an oxygen-containing gas such as air is fed through the second feed line directly to the combustion chamber.

To ignite the fuel in the combustion chamber 4, an igniting system 16 can be used.

The arrangement, depicted in FIGS. 1 and 2, of the first and second feed lines 2, 3, the line 22, and the inlet opening 19 in the form of concentric pipes is not necessary. For example, adjacent lines that lie parallel can also be used. In this sense, it is also not necessary that the valve 21 concentrically surround the first feed line 2, but rather it is, of course, also possible that the valve is at another position of the feed line 3 and already controls there the flow of the gaseous medium from the feed line 3, on the one hand, to the line 22 and, on the other hand, to the inlet opening 19.

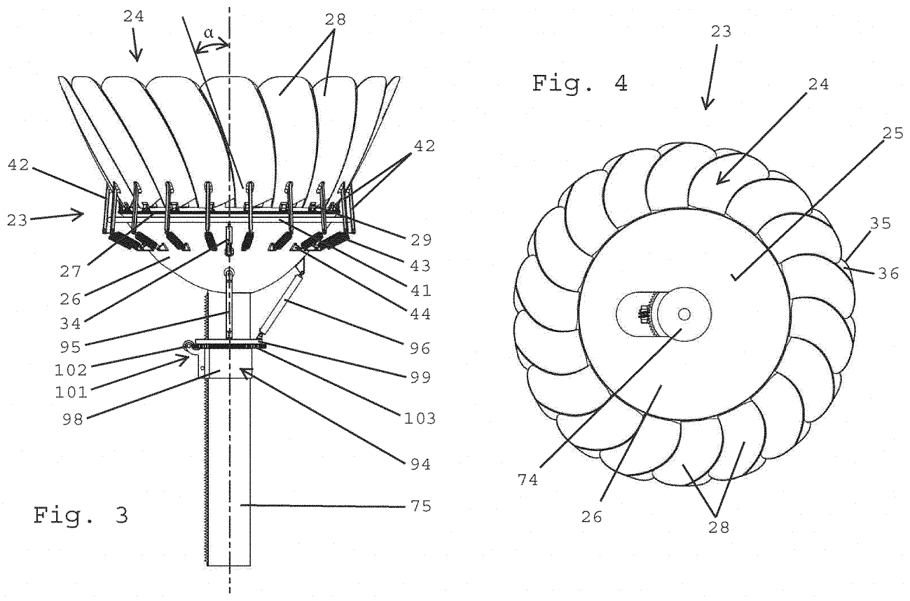

With reference to the drawings of FIGS. 3 to 27, preferred embodiments of thermal solar installations in the form of essentially parabolic concave mirrors are described. In principle, in the case of the invention, any concave mirror or any other thermal solar installation could be used, but the concave mirrors of FIGS. 3 to 27 have the advantage that they have movable fins, by which the attack surface of the respective concave mirror, e.g., in the case of strong wind or a storm, can be reduced. In the embodiment of FIGS. 3 to 18, in addition, the mirror surface of the concave mirror can be protected from damage or fouling.

The embodiments of concave mirrors according to FIGS. 3 to 27 and the embodiment of the heating head 74 with the holding device 75 can also be used regardless of the embodiment, depicted in FIGS. 1 and 2, of the device according to the invention with the heat exchanger and thus represent a separate invention.

In FIGS. 3 to 10, a first embodiment of a solar installation 23 according to the invention is depicted, which installation has a concave mirror 24, whose inside surface or mirror surface 25 has essentially the shape of a paraboloid of revolution. The concave mirror has a subpart or a base in the form of a bowl 26, on whose upper edge 27 adjustable sections in the form of elongated, somewhat curved fins 28 are mounted, which extend essentially in the direction of the generatrixes of the paraboloid of revolution, from which generatrixes are curved away in the peripheral direction but at increasing distance from the bowl at an increasing angle α. The fins 28 are connected via pivot bearings 29 to the bowl 26, whose swivel axes 31 lie in a plane that is parallel to the edge 27 of the bowl 26, but are inclined at an angle β of approximately 70° to a radial 33 of the bowl 26 (FIG. 7).

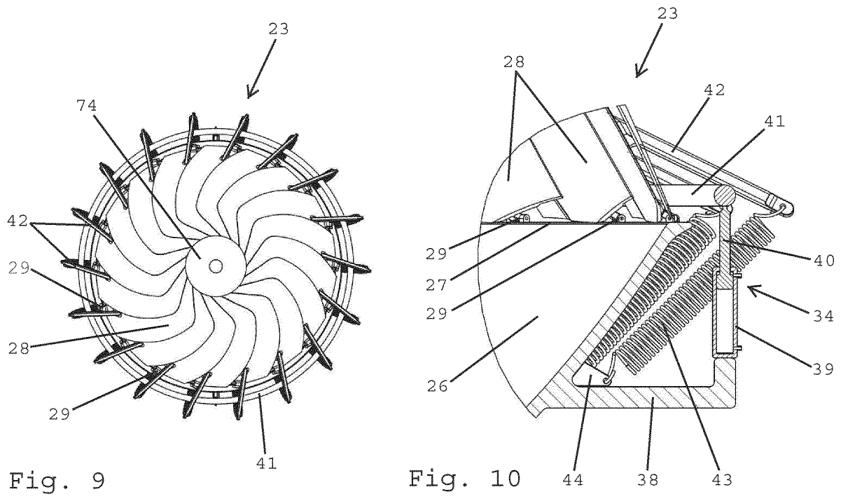

Because of this tilting of the swivel axes 31, the fins 28 are adjusted not radially inward but rather obliquely to the radial direction when pivoting from their operating position, depicted in FIGS. 3 to 6, into the resting position depicted in FIGS. 8 to 10. This has the advantage that when they pivot in the resting position, the fins 28 are not in each other's way but rather can lie close to one another.

As a swivel drive 34 for the fins 28, in the depicted embodiment of the invention, two pressure-medium cylinders 39, e.g., hydraulic or pneumatic cylinders, are used, which cylinders are mounted on opposite sides of the bowl 26 on a holding device 38 of the bowl 26. A piston 40 of the respective pressure-medium cylinder 39 is connected to a ring 41 that surrounds the bowl 26. Fastened to the fins 28 are rods 42, on whose free ends tension springs 43 are mounted, which rods are mounted at their other ends to attachments 44 on the bowl 26.

When the pistons 40 are run out by increasing the pressure in the cylinders 39, the ring 41 drives the rods 42 upward, by which the rods 42 pivot the fins 28 in the direction toward the center of the bowl 26. If, in contrast, the pressure in the cylinders 39 is released, the tension springs 43 pull the rods 42 back down again, by which the fins 28 are pivoted around the pivot bearings 29 again from the resting position into the operating position.

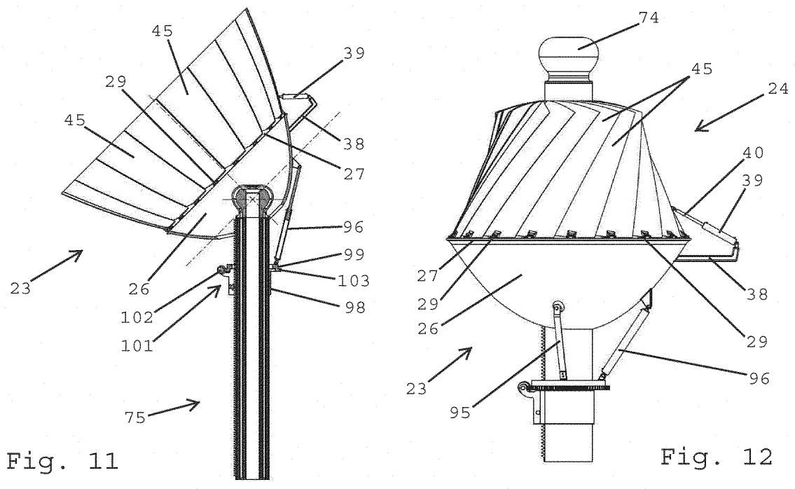

In FIGS. 11 to 13, an embodiment of a solar installation 23 according to the invention, simplified in comparison to the embodiment of FIGS. 3 to 10, is depicted, in which the fins 45 are straight and extend in the operating position, for example, in the direction of generatrixes of the paraboloid of revolution. As in the embodiment of FIGS. 3 to 10, the fins 45 are connected via pivot bearings 29 to the bowl 26, whose swivel axes 31 lie in a plane that is parallel to the edge 27 of the bowl 26. In this embodiment, the swivel axes 31, however, are all inclined at an angle β of approximately 83° to the radial 33 of the bowl 26.

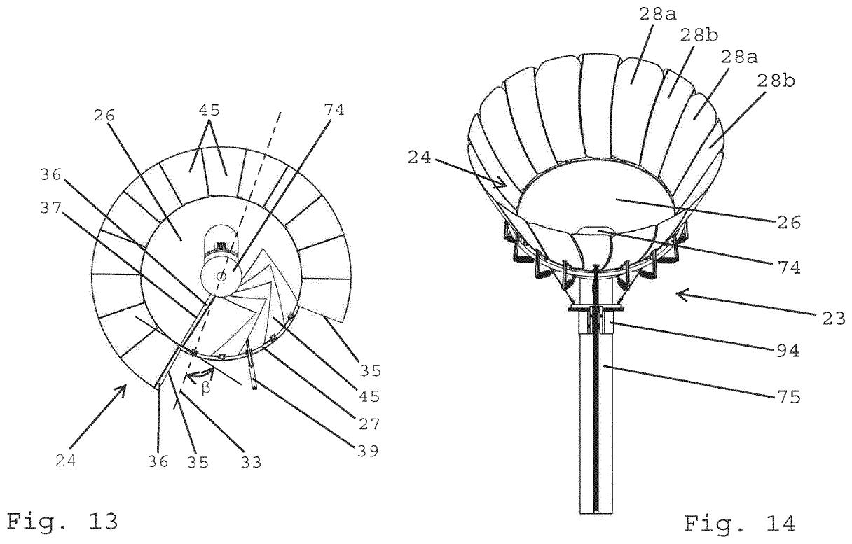

As a swivel drive 34 for the fins 45, in this embodiment, only a single pressure-medium cylinder 39, e.g., a hydraulic or pneumatic cylinder, is used, which, on the one hand, is mounted on a holding device 38 on the bowl 26 and, on the other hand, is mounted on one of the fins 45. When the piston 40 of the swivel drive 34 is run out, the nearest fin 45 is successively driven inward, in each case counterclockwise, as can be seen in FIG. 13 in one part of the fins 45, until all fins 45 have occupied the closed position depicted in FIG. 12 or the resting position. When, in contrast, the piston 40 is pulled back starting from the position depicted in FIGS. 12 and 13, the nearest fin is driven outward successively in each case clockwise until all fins have occupied the operating position depicted in FIG. 11.

This embodiment has the advantage that only a single fin 45 has to be pivoted by means of a swivel drive 34, and the thus actively-pivoted fin 45 successively entrains all other fins 45, since the latter also successively overlap the respective longitudinal edges 35.

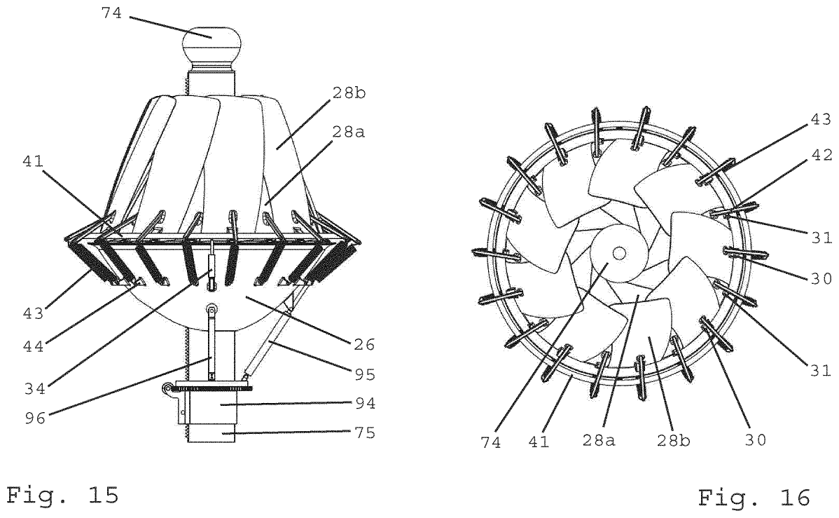

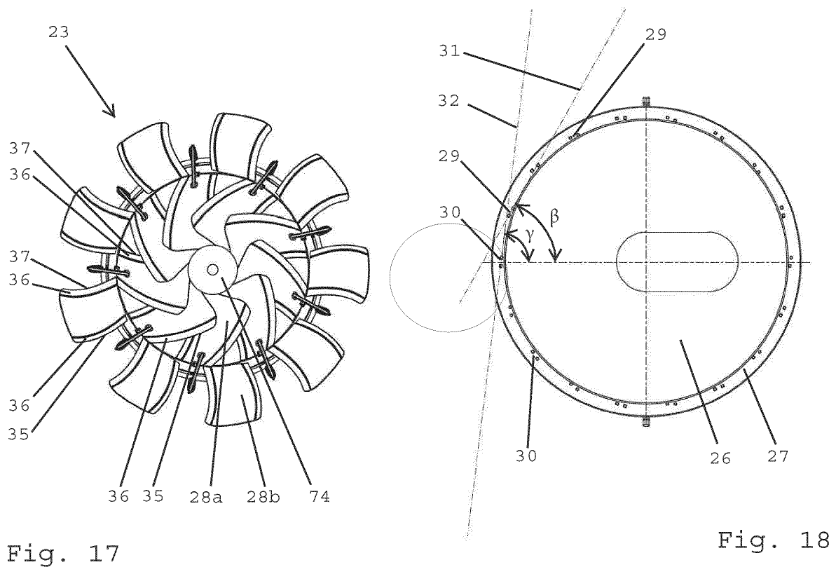

In FIGS. 14 to 18, a third embodiment of the solar installation according to the invention is depicted, which solar installation is similar to the solar installation depicted in FIGS. 3 to 10, but it has two rows of curved fins 28a, 28b. The fins 28a, 28b of the two rows are arranged alternately beside one another or somewhat overlapping, as can be seen in particular in FIG. 17, wherein one row of fins 28a is arranged inside and the second row of fins 28b is arranged outside.

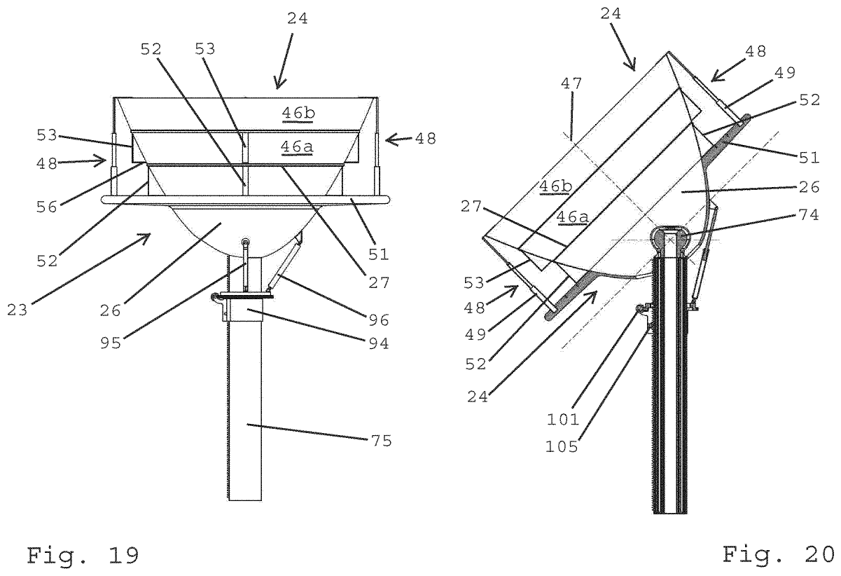

Unlike in the embodiment according to FIGS. 3 to 10, the fins 28a, 28b are mounted alternately on pivot bearings 29, 30 with differently-oriented swivel axes 31, 32 on the edge 27 of the bowl 26, wherein the swivel axes 31 of the fins 28a of the inner row are inclined at an angle β of approximately 60°, and the swivel axes 32 of the fins 28b of the outer row are inclined at an angle γ of approximately 83° to a radial 33 of the bowl 26 (FIG. 18).

For purposes of illustration, the fins 28a of the inner row are depicted in the resting position and the fins 28b of the outer row are depicted in the operating position in FIG. 17. Actually, all fins 28a, 28b with a common swivel drive 34, as was already described in the embodiment according to FIGS. 3 to 10, are simultaneously driven and pivoted.

In all described embodiments, each fin 28, 28a, 28b, 45 has an offset 36 on a longitudinal edge 35, with which offset it rests on the longitudinal edge 37 of the adjacent fin 28, 28a, 28b, 45. In the embodiment according to FIGS. 11 to 13, the overlapping of adjacent fins 45 is necessary, so that the driven fin 45 successively entrains the adjacent fins 45 when opening and closing the concave mirror 24. In addition, this overlapping has the advantage in all embodiments that the fins 28, 28a, 28b, 45 can rest on one another in the operating position, which ensures not only a more precise geometry of the mirror surface 25 but also the stability of the concave mirror 24 in the case of external weather effects, for example in the case of wind or snow. The offset 36 or overlapping of the individual fins 28, 28a, 28b, 45 can in this case be arranged both on respectively only one longitudinal edge 35 of each fin 28, 28a, 28b, 45 and, as FIG. 17 best illustrates, on both longitudinal edges 35, 37. Similarly, it is possible for fins to have alternating offsets 36 on both longitudinal edges 35, 37 or no offsets 36 at all. Alternatively or in addition, when the fins 28, 28a, 28b, 45 have a somewhat greater wall thickness, a longitudinal recess can also be applied on one edge 35 or both longitudinal edges 35, 37, in which recess the respective other longitudinal edge 35, 37 is accommodated in order to provide an overlapping of adjacent fins 28, 28a, 28b, 45.

In FIGS. 19 to 23, a fourth embodiment of the solar installation according to the invention is depicted, which is shown in FIG. 20 in the operating position and in section. This embodiment has annular fins 46a, 46b, wherein the lower annular fin 46a connects directly to the edge 27 of the bowl 26, and the upper annular fin 46b is adjacent to the subjacent annular fin 46a. The fins 46a, 46b can be moved in the direction of the axis 47 of the concave mirror. In principle, of course, it is also possible to use more than two or even only a single annular fin 46a, which is arranged to move relative to the bowl 26.

In the embodiment depicted in FIGS. 19 to 23, two pressure-medium cylinders 48 are provided on opposite sides of the concave mirror 24 to move the fins 46a, 46b. One cylinder 49 of each pressure-medium cylinder 48 is mounted on a holding device 51, which in the depicted embodiment has the shape of a disk, which is fastened to the bowl 26.

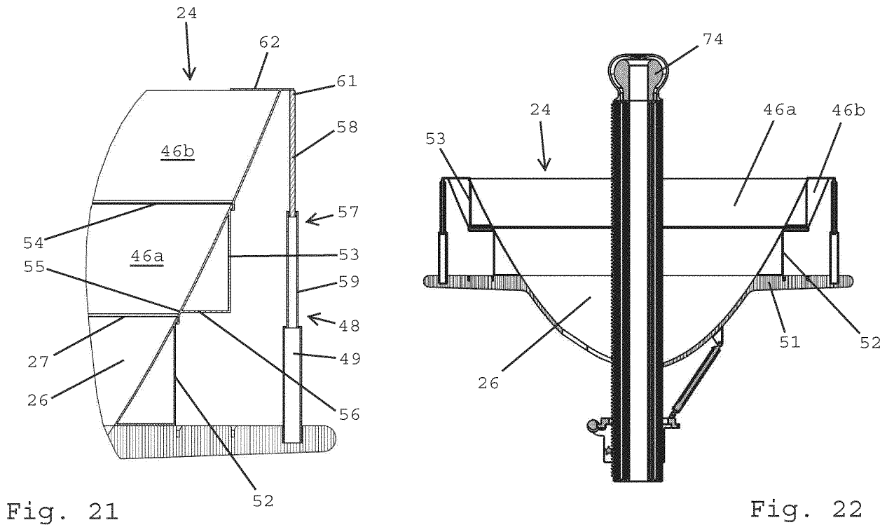

Between the edge 27 of the bowl 26 and the disk-shaped holding device 51, a total of four struts 52 are mounted, uniformly distributed around the periphery of the bowl 26. Struts 53 also arranged correspondingly are mounted on the lower fin 46a, which struts extend between an upper edge 54 of the lower fin 46a and strut 56, which lie in a radial plane and are arranged approximately at the height of the lower edge 55 of the fin 46a. The struts 52 and 53 are used to guide the overlying annular fins 46a, 46b in each case, when the fins 46a, 46b are moved from the operating position depicted in FIGS. 20 and 21 into the resting position depicted in FIG. 23.

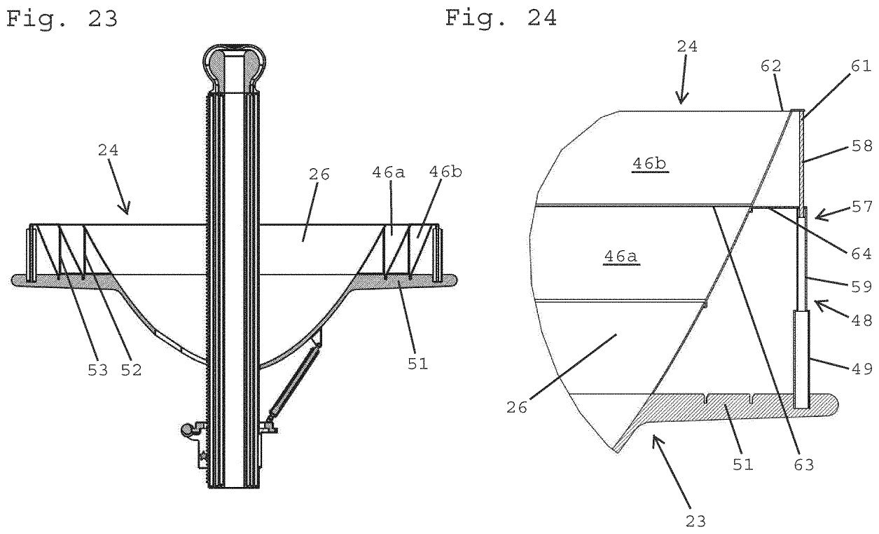

The pressure-medium cylinder 48 in the depicted embodiment has a 2-stage piston 57, wherein each stage has approximately the height of a fin 46a, 46b. The upper stage 58 of the piston 57 is connected on its free end 61 to the upper edge 62 of the upper fin 46b. When the pressure is released from the pressure-medium cylinder 48, the annular fins 46a, 46b are lowered by their own weight and in this case successively drive the 2-stage piston 57 of the pressure-medium cylinder 48 into the cylinder 49, as is depicted in FIG. 22, until the end position or resting position depicted in FIG. 23 is reached. When the pressure-medium cylinder 48 is pressurized, the two stages of the 2-stage piston 57 are driven in succession or simultaneously from the cylinder 49 and move the annular fins 46a, 46b into the position depicted in FIGS. 19 to 21.

In FIG. 24, another embodiment of the solar installation 23 according to the invention, slightly changed relative to the embodiment according to FIGS. 19 to 23, is depicted, in which solar installation the struts 52, 53 are omitted. Instead, the lower annular fin 46a is connected in the area of its upper edge 63 to a strap 64, which is connected to the upper end 65 of the lower stage 59 of the 2-stage cylinder 57. The lateral guiding of the two annular fins 46a, 46b is done in this embodiment by the pressure-medium cylinder 48, which is why the struts 52, 53 of the embodiment according to FIGS. 19 to 23 are not necessary. Aside from the difference that was just now described, the embodiment according to FIG. 24 is implemented like the embodiment according to FIGS. 19 to 23.

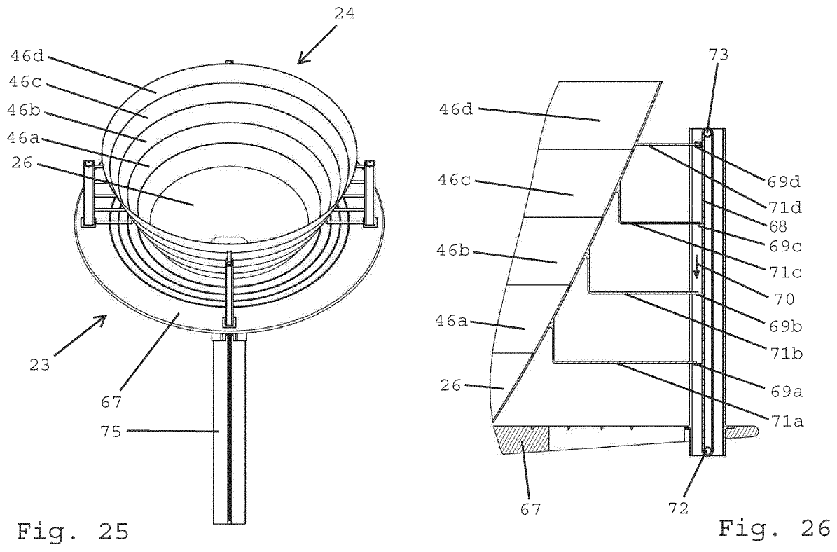

In FIGS. 25 to 27, an embodiment of the invention is depicted that has four annular fins 46a to 46d. As a drive for the fins 46a to 46d, a belt traction or chain traction 66 is attached to a disk-shaped holding device 67, which is mounted on the bowl 26, in each case offset by 90° on four sides of the concave mirror 24 in the depicted embodiment. Each belt traction or chain traction 66 has a continuous traction element 68 that runs around guide wheels 72, 73, on which carriers 69a to 69d are arranged, on which arms 71a to 71d attached to the annular fins 46a to 46d rest. The traction elements of motors, not depicted, that are connected to the lower guide wheels 72 are driven.

If the traction element 68 is moved counterclockwise in the direction of the arrow 70, the annular fins 46a to 46d are also moved downward by their own weight until the resting position that is depicted in FIG. 27 is achieved. The three lower carriers 69a to 69c project different distances from the traction element 68, wherein the lowermost carrier 69a projects most from the traction element 68 and the uppermost carrier 69c projects least from the traction element 68. The three lower arms 71a to 71c are also of different lengths, wherein the lowermost arm 71a ends at the greatest distance, the overlying arm 71b at a somewhat smaller distance, and the overlying arm 71c at a still smaller distance from the traction element 68. As a result, the carriers 69b and 69c can move past on the in each case subjacent arms 71a and 71b, when the traction element 68 is moved counterclockwise in the direction of the arrow 70.

The arms 71a to 71c on the three lower annular fins 46a to 46c only rest on the carriers 69a to 69c. The uppermost carrier 69d and the uppermost arm 71d are connected securely to one another, so that the fins 46a to 46c that are below the uppermost fin 46d are forced downward from the uppermost fin 46d if they do not automatically move downward under their own weight when the carriers 69a to 69c are moved downward.

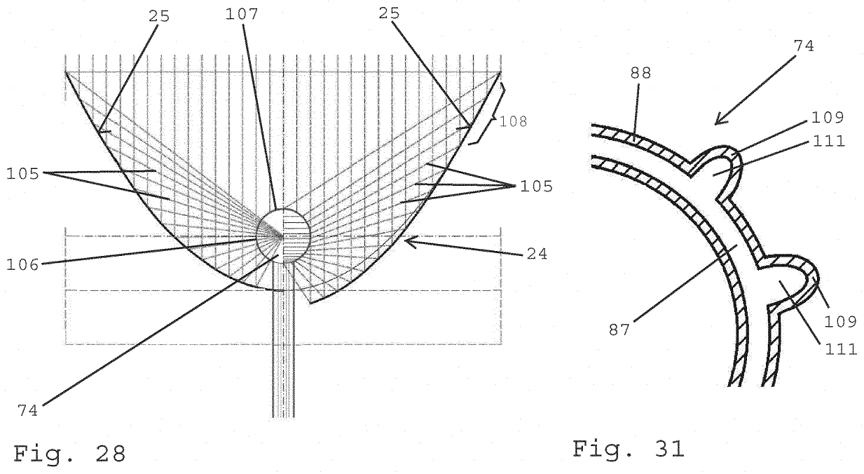

In FIG. 28, two different embodiments of the geometry of the mirror surface 25 and its effect on the irradiation of the reflected sunlight on the heating head 74 are depicted, wherein a parabolic mirror surface 25 is shown in the left half of FIG. 28, and a less curved mirror surface 25 is shown in the right half of FIG. 28.

As can be seen in the left half of FIG. 28, the reflected sunlight, indicated symbolically by the light beams 105, is reflected in the case of a parabolic mirror surface 25 only on a lateral area 106 of the heating head 74, at which point this area is heated significantly more than the upper area 107 of the heating head 74.

When, as depicted in the right half of FIG. 28, the mirror surface—viewed in the sectional plane—is less heavily curved, straight in particular in the upper edge area 108 or essentially straight, as is the case in a tapered surface, the upper part 107 of the heating head 74 can also be irradiated and thus heated by reflected sunlight, indicated symbolically by the light beams 105. Because of a suitable curvature of the concave mirror 24, solar radiation can thus be distributed advantageously uniformly onto the entire surface of the heating head 74.

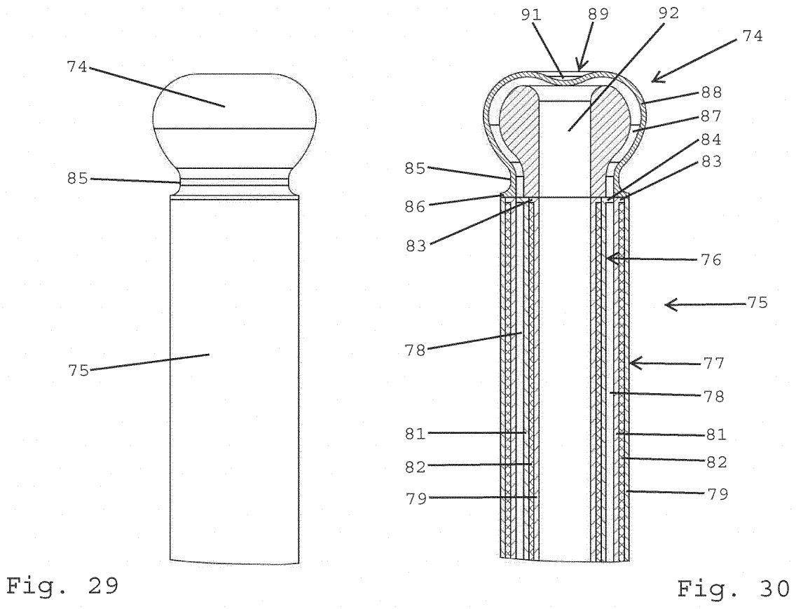

The thermal solar installation 23 according to the invention has a first embodiment, depicted in detail in FIGS. 29 and 30, of a rotationally-symmetrical heating head 74, which is mounted on the end of a holding device 75. The heating head 74 is arranged in the interior of the concave mirror 24, preferably precisely at the focal point of the concave mirror 24.

In the invention, any holding device can be used on which the heating head 74 is mounted, wherein the feeding and draining of the heat transfer medium have to be done via lines. In the case of the invention, however, it is preferred when the heating head 74 is arranged at the end of a rod-shaped or tube-like holding device 75, which has two concentric, preferably insulated, pipes 76, 77, which between them form an annular gap 78, wherein the feeding of the cooler, gaseous heat transfer medium to the heating head 74 is done through the annular gap 78 and the draining of the hotter, gaseous heat transfer medium is done through the inner pipe 76.

Each of the two pipes 76, 77 consists of an inner and outer casing 79, 81 with insulation 82 arranged in-between. On the end facing the heating head 74, the inner casings 79 of both pipes 76, 77 have a flange 83, projecting outward, as a spacer with respect to the outer casing 81 in each case. The outer casing 81 of the inner pipe 76 also has spacers 84 that are short, however, in the peripheral direction of the outer casing 81 only in order to hamper as little as possible the flow of the heat transfer medium through the annular gap 78 and into the heating head.

In the preferred embodiment depicted in the drawings, the heating head 74 has a rounded shape with a tapering section 85 in the area of the transition to the holding device 75. Because of the rounded shape, the sunbeams reflected by the concave mirror 24 on the heating head 74 strike preferably, for example, at a right angle to the surface of the heating head, which improves the effectiveness. Because of the tapering section 85, this is also possible for a larger portion of the sunbeams that strike the heating head 74 from below.

The heating head 74 is connected via a flange 86 to the tube-like holding device 75, wherein the annular gap 78 of the holding device 75 continues into an annular gap 87 in the heating head. The shape of the annular gap 87 that has an essentially consistent width is matched to the outside contour of the heating head 74 and is bounded by an outside wall 88 that is made adjacent to the flange 68 with consistent wall thickness.

At the crown 89 of the heating head 74, the latter has a central recess 91, which is located in extension of an inside pipe 92 of the heating head 74. The wall thickness of the outside wall 88 can thus also be kept largely constant even in the area where the annular gap 87 is curved inward on the crown 89 and turns into the inside pipe 92 of the heating head 74, which is in the extension of the inner pipe 76 of the holding device 75.

In FIG. 31, a diagrammatic section is depicted by a part of an improved embodiment of a heating head, in which the outside wall 88 has projections in the form of, for example, fins 109 that run around the heating head 74 in horizontal or vertical planes, in which fins flow channels 111 are arranged, which are open toward the annular gap 87. These projections designed, for example, as fins 109 increase the surface of the heating head 74 and thus improve the transfer of solar energy to the gaseous heat transfer medium, which flows through the annular gap 87 and the flow channels 111.

In order to further improve the transfer of heat from the outside wall 88 and the fins 109 to the gaseous heat transfer medium, the walls bounding the annular gap 87 and the flow channels 111 can be designed to be rough in such a way that the gaseous heat transfer medium flows in the form of a turbulent flow through the annular gap 87 and the flow channels 111.

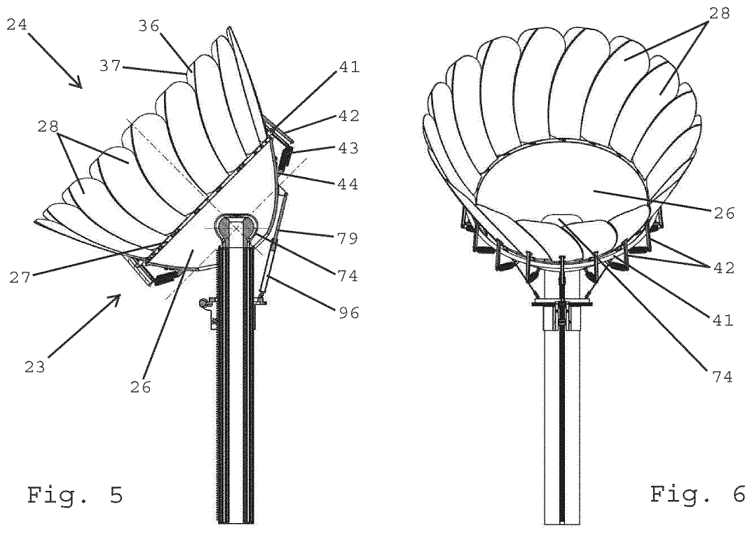

In order to be able to follow in the vertical direction the position of the sun changing over the course of a day, a slot 93 is attached in the area of the base of the bowl 26 in all described embodiments of the solar installation 23 according to the invention, through which slot the holding device 75 is run. Along the holding device 75, a positioning element 94 can move, on which element, on the one hand, two struts 95 are mounted on opposite sides of the bowl 26, and, on the other hand, a pressure-medium cylinder 96 is mounted in a hinged manner. If the piston 97 of the pressure-medium cylinder 96 is run out, the concave mirror 24 is pivoted from the resting position, depicted in, for example, FIG. 3, into the operating position depicted in, for example, FIG. 5, in which operating position, its axis of rotation in the vertical direction is oriented optimally to the sun.

So that the concave mirror 24 can follow the sun even in the horizontal direction, the struts 95 and the pressure-medium cylinder 96 are mounted on a flange 99 that can rotate relative to a guide sleeve 98. Arranged on the guide sleeve is a drive, not depicted, of a worm gear 101, which drives a worm 102, which is engaged with a worm wheel 103 on the flange 99. The sleeve 98 can move in the longitudinal direction of the holding device 75, but cannot rotate relative to the latter. By the drive with the worm gear 101, the concave mirror 24 can thus be rotated relative to the holding device 75.

The concave mirror 24 can move along the holding device 75, in order to be able to move it from a raised position (e.g., FIGS. 3 and 5), in which the heating head 74 is arranged at its center or focal point, into a lowered position (e.g., FIG. 8 or 22), in which the heating head 74 is arranged outside. For this purpose, a gear rack 104 is attached to the holding device 75, on which rack there acts a pinion gear 105 that is mounted on the guide sleeve 98 and driven by a drive, not shown. By rotating the pinion gear 105 by means of the drive, the concave mirror 24 can be moved back and forth along the holding device 75.

The heat released by the heat exchanger 1 according to the invention can continue to be used for any purpose, for example for heating buildings, plants, or production units, or else also can be fed to additional processes, such as thermal (thermodynamic) processes. In addition, the heat exchanger according to the invention can also be used in connection with a compression thermal engine, e.g., a Stirling engine, which has a first space for heating a working medium and a second space, connected to the first space, for cooling the working medium, wherein the working medium is heated in the first space via the heat exchanger according to the invention.

Reference Symbol List:
1 Heat exchanger
2 First feed line
3 Second feed line
4 Combustion chamber
5 Arrow, first flow
6 Pipe, second flow
7 Base
8 Boundary wall
9 Cover
10 Annular gap
11 Inner annular space
12 Inner dividing wall
13 Outlet
14 Outer annular space
15 Middle annular space
16 Igniting system
17 Outside wall
18 Outer dividing wall
19 Inlet opening
20 Nozzle
21 Valve
22 Line
23 Solar installation
24 Concave mirror
25 Mirror surface
26 Bowl
27 Edge
28 Curved fin
28a Curved fin
28b Curved fin
29 Pivot bearing
30 Pivot bearing
31 Swivel axes
32 Swivel axes
33 Radial
34 Swivel drive
35 Longitudinal edge
36 Offset
37 Longitudinal edge
38 Holding device
39 Pressure-medium cylinder
40 Piston
41 Ring
42 Rods
43 Tension springs
44 Attachments
45 Straight fin
46a Annular fin
46b Annular fin
46c Annular fin
46d Annular fin
47 Axis of the concave mirror
48 Pressure-medium cylinder
49 Cylinder
50 Source
51 Disk-shaped holding device
52 Strut
53 Strut
54 Upper edge
55 Lower edge
56 Strut
57 2-Stage piston
58 Upper stage
59 Lower stage
60 ---
61 Free end
62 Upper edge
63 Upper edge
64 Strap
65 Upper end
66 Belt or chain traction
67 Holding device
68 Traction element
69a Carrier
69b Carrier
69c Carrier
69d Carrier
70 Arrow
71a Arm
71b Arm
71c Arm
71d Arm
72 Guide wheel
73 Guide wheel
74 Heating head
75 Holding device
76 Inner pipe
77 Outer pipe
78 Annular gap
79 Inner casing
80 -
81 Outer casing
82 Insulation
83 Flange
84 Spacer
85 Tapering section
86 Flange
87 Annular gap
88 Outside wall
89 Crown
90 -
91 Recess
92 Inside pipe
93 Slot
94 Positioning element
95 Strut
96 Pressure-medium cylinder
97 Piston
98 Guide sleeve
99 Flange
100 --
101 Worm gear
102 Worm
103 Worm wheel
104 Gear rack
105 Light beams
106 Lateral area
107 Upper area
108 Upper edge area
109 Fin-like projections
110 --
111 Flow channels
α Angle
β Angle
γ Angle

1. Device with a heat exchanger with a first flow, through which a first gaseous heat transfer medium passes, and with a second flow, through which a second gaseous heat transfer medium passes, wherein upstream from the first flow, there is arranged a combustion chamber, wherein two feed lines are attached to the first flow, the first feed line of which is connected to a thermal solar installation and the second feed line is connected to a source for a combustible gas-air mixture or for a non-combustible gas.

2. Device according to claim 1, wherein a valve is arranged in the second feed line, which valve connects the second feed line to a line to the thermal solar installation and interrupts the connection of the second feed line to the heat exchanger or controls the flow through the second feed line.

3. Device according to claim 1, wherein a first cutoff valve or control valve is arranged in the first feed line, and wherein a second cutoff valve or control valve is arranged in a line to the thermal solar installation or in the second feed line.

4. Device according to claim 1, wherein an igniting system is arranged in the combustion chamber.

5. Device according to claim 1, wherein a system is provided for feeding fuel directly into the combustion chamber.

6. Device according to claim 1, wherein the solar installation has a concave mirror.

7. Device according to claim 6, wherein the concave mirror has a mirror surface that is parabolically and/or conically curved at least in sections.

8. Device according to claim 6,
wherein the mirror surface is formed at least in part from adjustable sections.

9. Device according to claim 8, wherein on the device's base, the concave mirror has a bowl with a parabolic mirror surface and wherein the adjustable sections are mounted on the bowl.

10. Device according to claim 9, wherein the adjustable sections are fins that extend essentially in the direction of the generatrixes and that are hinged to the bowl via pivot bearings.

11. Device according to claim 9, wherein the adjustable sections are annular fins that, starting from the bowl, are aligned in the direction of the axis of the paraboloid.

12. Device according to claim 6, further comprising a heating head, which is arranged in an operating position in the interior of the concave mirror.

13. Device according to claim 12, wherein the heating head is arranged on the end of a holding device, which has two concentric pipes, which between them form an annular gap and wherein the feeding of the cooler, gaseous heat transfer medium to the heating head is done through the annular gap and the removal of the hotter, gaseous heat transfer medium is done through the inner pipe.

14. Device according to claim 12, wherein the heating head has a rotationally-symmetrical shape.

15. Device according to claim 12, wherein the heating head has an annular gap, through which the heat transfer medium is routed and which is matched to the outside contour of the heating head.

16. Device according to claim 15, wherein the annular gap in the heating head is in extension of the annular gap of the holding device.

17. Device according to claim 12, wherein wall surfaces of the annular gap are rough or uneven, so that a turbulent flow of the heat transfer medium in the annular gap is produced.

18. Device according to claim 12, wherein an outside wall of the heating head has fin-like projections.

19. Device according to claim 18, wherein flow channels are arranged in the fin like projections.

20. Device according to claim 16, wherein the concave mirror is arranged to move relative to the holding device.

21. Device according to claim 13, wherein the concave mirror is arranged to pivot relative to the holding device.

22. Device according to claim 13, wherein the holding device is arranged to be stationary.

23. Device according to claim 13, wherein the concave mirror has a slot that is arranged along a generatrix of the concave mirror, and wherein the holding device is run through the slot.

24. Compression thermal engine, with a first space for heating a working medium and a second space, connected to the first space, for cooling the working medium, wherein according to claim 1, the first flow of the device is connected to the first space.
